(19) United States
(12) Patent Application Publication
(10) Pub. No.: US 2026/0155302 A1
(43) Pub. Date: Jun. 4, 2026

(54) DIELECTRIC POWDER, METHOD OF PREPARING THE SAME, AND MULTILAYER CERAMIC CAPACITOR INCLUDING THE SAME

(71) Applicant: SAMSUNG ELECTRO-MECHANICS CO., LTD., Suwon-si (KR)

(72) Inventors: Taeyoon Kim, Suwon-si (KR); Huieun Kim, Suwon-si (KR); Wonhyung Kim, Suwon-si (KR)

(73) Assignee: SAMSUNG ELECTRO-MECHANICS CO., LTD., Suwon-si (KR)

(21) Appl. No.: 19/214,997

(22) Filed: May 21, 2025

(30) Foreign Application Priority Data
Dec. 2, 2024 (KR) 10-2024-0176595
Dec. 6, 2024 (KR) 10-2024-0180485

(51) Int. Cl. H01G 4/10; C04B 35/468; C04B 35/626; C04B 35/628; H01G 4/008; H01G 4/12; H01G 4/232; H01G 4/248; H01G 4/30

(52) U.S. Cl. CPC H01G 4/10; C04B 35/468; C04B 35/62675; C04B 35/62805; C04B 35/62886; C04B 35/62894; H01G 4/008; H01G 4/1227; H01G 4/2325; H01G 4/248; H01G 4/30; C04B 2235/3236; C04B 2235/3293; C04B 2235/483

(57) ABSTRACT

Provided are a dielectric powder, a multilayer ceramic capacitor using the same, and a method of preparing the same, the dielectric powder including a core including barium (Ba) and titanium (Ti); a first layer disposed on at least a portion of the core; and a second layer disposed on at least a portion of the first layer, wherein at least one of the first layer and the second layer includes at least one first element selected from silicon (Si) and aluminum (Al), the first layer and the second layer include at least one second element selected from tin (Sn), copper (Cu), iron (Fe), zinc (Zn), and manganese (Mn).

### CROSS-REFERENCE TO RELATED APPLICATION

This application claims priority to and the benefit of Korean Patent Application No. 10-2024-0180485 filed in the Korean Intellectual Property Office on Dec. 6, 2024, and Korean Patent Application No. 10-2024-0176595 filed in the Korean Intellectual Property Office on Dec. 2, 2024, the entire contents of which are incorporated herein by reference.

### BACKGROUND

The present disclosure relates to a dielectric powder, a method of preparing the same, and a multilayer ceramic capacitor including the same.

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the miniaturization of multilayer ceramic capacitors, the importance of atomization of dielectric base material powder and distribution of additives is increasing.

### SUMMARY

An embodiment provides a dielectric powder with minimized core damage of a dielectric base material.

Another embodiment provides a method for preparing the dielectric powder.

Another embodiment provides a multilayer ceramic capacitor with excellent temperature characteristics and reliability.

An embodiment provides a dielectric powder including a core including barium (Ba) and titanium (Ti); a first layer disposed on at least a portion of the core; and a second layer disposed on at least a portion of the first layer, wherein at least one of the first layer or the second layer includes at least one first element selected from the group consisting of silicon (Si) and aluminum (Al), and the first layer and the second layer include at least one second element selected from the group consisting of tin (Sn), copper (Cu), iron (Fe), zinc (Zn), and manganese (Mn).

The first layer and the second layer may include the tin (Sn), and when analyzing a TEM-EDS (transmission electron microscope-energy dispersive spectroscopy) for a straight-line section from a center of the dielectric powder to one boundary, the first layer may be a region where tin (Sn) is greater than or equal to about 0.2 part by mole based on 100 parts by mole of titanium (Ti), and the core and the second layer may be regions where tin (Sn) is less than about 0.2 part by mole based on 100 parts by mole of titanium (Ti).

A content of the second element may be higher in the first layer than in the second layer.

The first layer and the second layer may include the first element.

The first layer and the second layer may include the second element in a form of an oxide.

At least one of the first layer and the second layer may include silicon (Si), and the first layer and the second layer may include tin (Sn).

The first layer and the second layer may include silicon (Si) and tin (Sn).

Another embodiment provides a multilayer ceramic capacitor prepared by using the dielectric powder, including: a capacitor body including a dielectric layer and an internal electrode layer, and an external electrode disposed on an outer surface of the capacitor body, wherein the dielectric layer prepared by using the dielectric powder includes a plurality of dielectric grains and a grain boundary disposed between the plurality of dielectric grains, and at least one of the plurality of dielectric grains has a core-shell structure including a core portion and a shell portion disposed on at least a portion of the core portion, and the shell portion and the grain boundary include at least one first element selected from the group consisting of silicon (Si) and aluminum (Al), and at least one second element selected from the group consisting of tin (Sn), copper (Cu), iron (Fe), zinc (Zn), and manganese (Mn).

A molar ratio of a total amount of the second element to a total amount of the first element in the shell portion may be greater than about 0.15 and less than about 1.0.

A molar ratio of the second element included in the shell portion to the second element included in the grain boundary may be greater than or equal to about 2.0 and less than about 6.0.

The core portion may include barium (Ba) and titanium (Ti).

The shell portion and the grain boundary may include silicon (Si) and tin (Sn).

Another embodiment provides a method for preparing the dielectric powder, including: adding a metal alkoxide-based compound to a solution including a barium titanate-based compound and performing a hydrothermal treatment to primarily coat the surface of the barium titanate-based compound with the metal alkoxide-based compound; and adding a metal oxide after the primary coating and performing a hydrothermal treatment to secondarily coat the surface of the metal alkoxide-based compound with the metal oxide, wherein the metal alkoxide-based compound includes at least one metal selected from the group consisting of silicon (Si) and aluminum (Al), and the metal oxide includes at least one metal selected from the group consisting of tin (Sn), copper (Cu), iron (Fe), zinc (Zn), and manganese (Mn).

The metal alkoxide-based compound may include at least one selected from the group consisting of tetraethyl orthosilicate (TEOS), aluminum isopropoxide, and aluminum ethoxide.

The metal alkoxide-based compound may be added in an amount such that the metal of the metal alkoxide-based compound may be in an amount of about 0.1 part by mole to about 1 part by mole based on 100 parts by mole of the barium titanate-based compound.

The metal oxide may include at least one selected from the group consisting of tin oxide (SnO₂), copper oxide (CuO), iron oxide (FeO, Fe₃O₄, or Fe₂O₃), zinc oxide (ZnO), and manganese dioxide (MnO₂).

The metal oxide may be added in an amount such that the metal of the metal oxide may be in an amount of about 0.1 part by mole to about 3 parts by mole based on 100 parts by mole of the barium titanate-based compound.

In the primary coating, the hydrothermal treatment may be performed at a temperature of about 100° C. to about 300° C.

In the secondary coating, the hydrothermal treatment can be performed at a temperature of about 150° C. to about 350° C.

A dielectric powder according to some embodiments of the present disclosure can minimize core damage of a dielectric base material by doping of an additive. Multilayer ceramic capacitors using such dielectric powder can improve temperature characteristics and reliability.

### BRIEF DESCRIPTION OF THE DRAWINGS

FIG. 1 is a schematic view showing a dielectric powder according to an embodiment.

FIG. 2 is a perspective view showing a multilayer ceramic capacitor according to an embodiment.

FIG. 3 is a cross-sectional view of the multilayer ceramic capacitor taken along line I-I′ of FIG. 2.

FIG. 4 is a cross-sectional view of the multilayer ceramic capacitor taken along line II-II′ of FIG. 2.

FIG. 5 is an exploded perspective view showing the stacked structure by disassembling the capacitor body of FIG. 2.

FIG. 6 is a schematic view showing a dielectric layer according to an embodiment.

FIG. 7A is an HR-TEM (high-resolution transmission electron microscope) analysis image of the dielectric powder according to Preparation Example 1.

FIG. 7B is an IFFT HR-TEM (inverse Fourier transform high-resolution transmission electron microscope) analysis image of the dielectric powder according to Preparation Example 1.

FIGS. 8A to 8C are TEM-EDS (transmission electron microscope-energy dispersive spectroscopy) analysis images of the dielectric powder according to Preparation Example 1.

FIGS. 9A and 9B are TEM-EDS (transmission electron microscope-energy dispersive spectroscopy) line analysis images for the dielectric powder according to Preparation Example 1, and FIG. 9C is a TEM-EDS (transmission electron microscope-energy dispersive spectroscopy) line analysis graph for the dielectric powder according to Preparation Example 1.

FIGS. 10A to 10D are TEM-EDS (transmission electron microscopy-energy dispersive spectroscopy) mapping analysis images for a dielectric layer according to Example 1.

FIG. 11A is a TEM-EDS (transmission electron microscope-energy dispersive spectroscopy) line analysis image for a dielectric layer according to Example 1, and FIG. 11B is a TEM-EDS (transmission electron microscope-energy dispersive spectroscopy) line analysis graph for a dielectric layer according to Example 1.

FIG. 12 is a graph showing the reliability of the multilayer ceramic capacitor according to Example 1.

FIG. 13 is a graph showing the reliability of the multilayer ceramic capacitor according to Comparative Example 1.

### DETAILED DESCRIPTION OF THE EMBODIMENTS

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

Additionally, throughout the specification, when it is said to ‘include as a main component’, it means that among at least one component present in an area, one component has the highest content based on a total amount of components.

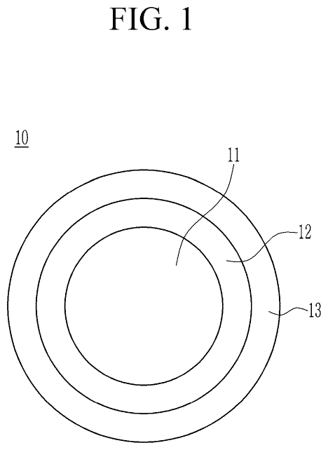

A dielectric powder according to an embodiment is described with reference to FIG. 1.

FIG. 1 is a schematic view showing a dielectric powder according to an embodiment.

Referring to FIG. 1, a dielectric powder 10 according to some embodiments may include a core 11, a first layer 12 disposed on at least a portion of the core 11, and a second layer 13 disposed on at least a portion of the first layer 12. In some embodiments, the first layer 12 may be disposed on the entire surface of the core 11, and/or the second layer 13 may be disposed on the entire surface of the first layer 12.

In FIG. 1, the first layer 12 is depicted as a structure that surrounds the entire core 11 and the second layer 13 is depicted as a structure that surrounds the entire first layer 12, but this is only an example of the structure of the dielectric powder and the present disclosure is not limited thereto.

The core 11 may include barium (Ba) and titanium (Ti). At least one of the first layer 12 or the second layer 13 may include one or more first elements selected from the group consisting of silicon (Si) and aluminum (Al), and the first layer 12 and the second layer 13 may include one or more second elements selected from the group consisting of tin (Sn), copper (Cu), iron (Fe), zinc (Zn), and manganese (Mn).

The components of the core 11 may be derived from a barium titanate-based compound, which is a dielectric base material, and the components of the first layer 12 and the second layer 13 may be derived from an additive. The additive may include the first elements and the second elements. That is, since the additive is doped in a double layer structure of the first layer 12 and the second layer 13 on at least a portion of the core 111, damage to the core due to doping of the additive can be minimized. Therefore, the dielectric powder having the structure and composition can improve the temperature characteristics of the dielectric.

At least one of the first layer 12 or the second layer 13 may include a first element. According to some embodiments, the first element may include, for example, silicon (Si). According to some embodiments, the first element may include, for example, aluminum (Al). Additionally, according to some embodiments, the first layer 12 and the second layer 13 both may include the first element. According to some embodiments, the first layer may include at least one of the first element selected from the group consisting of silicon (Si) and aluminum (Al). According to some embodiments, the second layer may include at least one of the first element selected from the group consisting of silicon (Si) and aluminum (Al).

According to some embodiments, the first layer 12 and the second layer 13 may include a second element. According to some embodiments, the second element may be derived from an internal diffusion additive, and may include, for example, tin (Sn). According to some embodiments, the second element may be selected from the group consisting of tin (Sn), copper (Cu), iron (Fe), zinc (Zn), and manganese (Mn).

The second element may be included in a higher content in the first layer 12 than in the second layer 13. When the content of the second element, such as Sn, is higher in the first layer 12 than in the second layer 13, the diffusion of the additive component into the dielectric grains may be suppressed, thereby improving the temperature characteristics of the dielectric.

The second element may exist in a form of an oxide in the first layer 12 and the second layer 13.

For example, at least one of the first layer 12 and the second layer 13 may include silicon (Si), and the first layer 12 and the second layer 13 may include tin (Sn).

Also, as an example, both the first layer 12 and the second layer 13 may include silicon (Si) and tin (Sn).

The structure of the dielectric powder 10 may be confirmed through HR-TEM (high-resolution transmission electron microscopy) or IFFT HR-TEM (inverse Fourier transform high-resolution transmission electron microscopy) analysis.

Specifically, the dielectric powder 10 may be measured using HR-TEM or IFFT HR-TEM under conditions of an acceleration voltage of 200 kV and a magnification of 630 k. The core 11, the first layer 12, and the second layer 13 may be distinguished and confirmed through the measured image.

Additionally, the structure and components of the dielectric powder 10 may also be confirmed through TEM-EDS (transmission electron microscope-energy dispersive spectroscopy).

Specifically, the structure and components of the dielectric powder 10 may be confirmed by measuring with a transmission electron microscope (TEM) under conditions of an acceleration voltage of 200 kV and a magnification of 630 k, and performing an energy dispersive spectroscopy (EDS) analysis on the measured TEM image. Additionally, the composition of the dielectric powder may be confirmed by performing EDS line analysis on a straight-line section from a center of the dielectric powder to one boundary in the measured TEM image.

For example, when the first layer 12 and the second layer 13 include Sn, when analyzing the TEM-EDS for a straight-line section from the center of the dielectric powder to the boundary on one side, the core 11, the first layer 12, and the second layer 13 may be distinguished based on the point where Sn is about 0.2 part by mole relative to 100 parts by mole of Ti. That is, the first layer 12 may be defined as a region where Sn is greater than or equal to about 0.2 part by mole relative to 100 parts by mole of Ti, and the core 11 and the second layer 13 may be defined as regions where Sn is less than 0.2 part by mole relative to 100 parts by mole of Ti wherein an internal region toward the center of the dielectric powder based on the first layer 12 may be defined as the core 11 and an external region toward the outside based on the first layer 12 may be defined as the second layer 13.

The aforementioned dielectric powder may be prepared by the following method:
adding a metal alkoxide-based compound to a solution including a barium titanate-based compound and performing a hydrothermal treatment to primarily coat the surface of the barium titanate-based compound with the metal alkoxide-based compound; and adding a metal oxide after the primary coating and performing a hydrothermal treatment to secondarily coat the surface of the metal alkoxide-based compound with the metal oxide.

The barium titanate-based compound is a compound containing barium (Ba) and titanium (Ti), and may include at least one selected from the group consisting of BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, and (Ba, Sr)(Ti, Sn)O₃.

The metal alkoxide-based compound may be an alkoxide-based compound containing one or more metals selected from silicon (Si) and aluminum (Al). In the dielectric powder 10 according to some embodiments, the first element may be derived from the metal alkoxide-based compound that is primarily coated on the surface of the barium titanate-based compound.

The metal oxide may be an oxide containing one or more metals selected from the group consisting of tin (Sn), copper (Cu), iron (Fe), zinc (Zn), and manganese (Mn). In another embodiment, the second element in the dielectric powder 10 may be derived from the metal oxide that is secondarily coated on the surface of the primarily-coated metal alkoxide-based compound.

According to a method for preparing a dielectric powder of the present disclosure, a first layer as a barrier layer that blocks the movement of an internal diffusion additive corresponding to a metal oxide to be secondarily coated is formed by primarily coating a metal alkoxide-based compound on the surface of a barium titanate-based compound. In addition, by secondarily coating a metal oxide on the surface of the primarily-coated metal alkoxide-based compound, a second layer as a barrier layer corresponding to an internal diffusion additive layer is additionally formed on the first barrier layer, thereby minimizing damage to the core. That is, by forming a double additive layer, core damage caused by additive doping is minimized, and the temperature characteristics of the dielectric may be easily secured.

Specifically, the primary coating may form a first layer as a barrier layer of on the surface of the powder by adding a metal alkoxide-based compound to a solution including a barium titanate-based compound powder whose grain growth has been completed, and then dissolving and re-precipitating the compound. That is, a coating layer may be formed by precipitating reactants with Ba and Ti on the surface of a barium titanate-based compound through polymerization and neutralization reactions following hydrolysis of the added metal alkoxide-based compound.

The solution including the barium titanate-based compound may be an aqueous solution or an organic solution, for example, an aqueous solution. For aqueous solutions, it may be, for example, a solution with a pH higher than 7.

The metal alkoxide-based compound may include one or more selected from, for example, tetraethyl orthosilicate (TEOS), aluminum isopropoxide, and aluminum ethoxide.

The metal alkoxide-based compound may be added in an amount such that the metal of the metal alkoxide-based compound may be in an amount of about 0.1 part by mole to about 1 part by mole based on 100 parts by mole of the barium titanate-based compound, and such that the metal such as Si may be, for example, in an amount of about 0.1 part by mole to about 0.8 part by mole, or about 0.2 part by mole to about 0.6 part by mole based on 100 parts by mole of the barium titanate-based compound. When the metal alkoxide-based compound is added in the above content range, a first layer as a barrier layer that blocks the movement of the internal diffusion additive may be easily formed.

In the primary coating, the hydrothermal treatment can be performed at a temperature of about 100° C. to about 300° C., for example, at a temperature of about 150° C. to about 250° C. When the hydrothermal treatment for the primary coating is performed within the above temperature range, the metal alkoxide-based compound is stably hydrolyzed, so that the primary coating may be easily performed on the surface of the barium titanate-based compound.

In addition, in the primary coating, the temperature may be maintained and stirred for a certain period of time, for example, more than about 30 minutes, to ensure sufficient hydrolysis of the metal alkoxide-based compound. In addition, the reaction time and temperature may be controlled depending on the amount of the added metal alkoxide-based compound and the type of material, and the reaction temperature may be lower than the temperature for grain growth of the barium titanate-based compound.

In addition, the secondary coating may form a second layer as a barrier layer of on the surface of the powder by adding a metal oxide to a solution including a barium titanate-based compound powder on which the first layer as the barrier layer is formed through the primary coating, and then dissolving and re-precipitating the compound.

The metal oxide may include one or more selected from, for example, the group consisting of tin oxide (SnO₂), copper oxide (CuO), iron oxide (FeO, Fe₃O₄, or Fe₂O₃), zinc oxide (ZnO), and manganese dioxide (MnO₂). The metal oxide may be used, for example, in the form of a sol solution in which the metal oxide is dispersed in an alkaline solvent.

The metal oxide may be added in an amount such that the metal of the metal oxide may be in an amount of about 0.1 part by mole to about 3 parts by mole based on 100 parts by mole of the barium titanate-based compound, and a metal such as Sn may be in an amount of about 0.2 part by mole to about 2.5 parts by mole, or about 0.5 part by mole to about 2.0 parts by mole based on 100 parts by mole of the barium titanate-based compound. When the metal oxide is added in the above content range, the second layer of the internal diffusion additive layer is easily formed on the first layer, thereby minimizing damage to the core.

In the secondary coating, the hydrothermal treatment may be performed at a temperature of about 150° C. to about 350° C., for example, at a temperature of about 200° C. to about 300° C. When the secondary coating is performed by thermal treatment within the above temperature range, the secondary coating may be easily performed on the surface of the barium titanate-based compound as the metal oxide is stably dissolved and re-precipitated.

Additionally, in the secondary coating, the temperature may be maintained for a certain period of time, for example, more than about 2 hours, to ensure sufficient dissolution of the metal oxide. In addition, the reaction time and temperature may be controlled depending on the amount of metal oxide and the type of material, and the reaction temperature may be lower than the temperature for grain growth of the barium titanate-based compound.

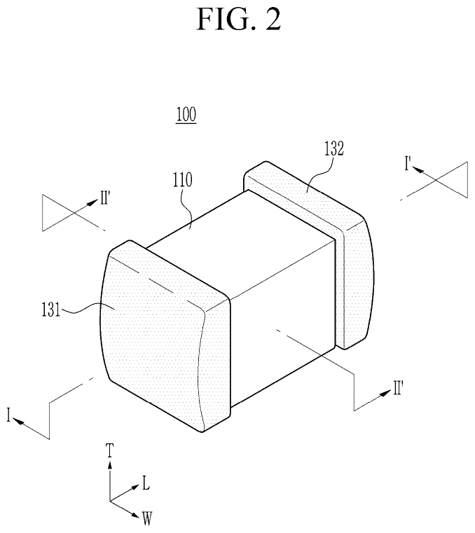

Hereinafter, a multilayer ceramic capacitor using the aforementioned dielectric powder is described with reference to FIGS. 2 to 5.

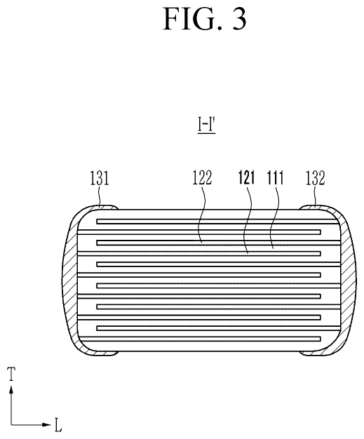

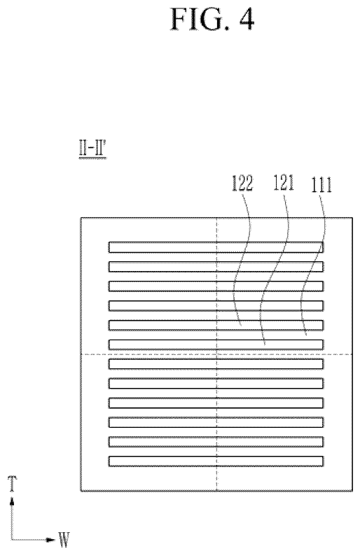

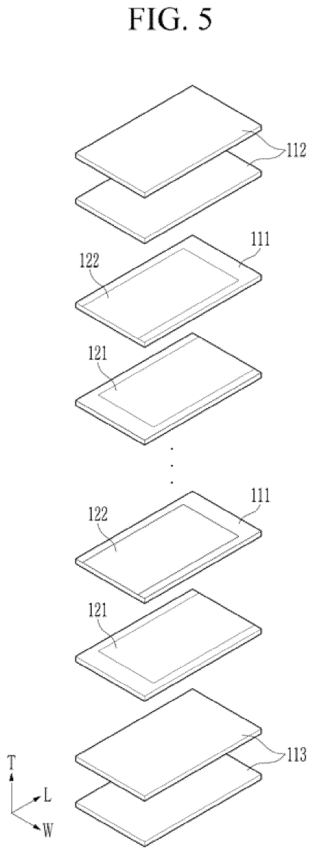

FIG. 2 is a perspective view showing a multilayer ceramic capacitor according to an embodiment, FIG. 3 is a cross-sectional view of the multilayer ceramic capacitor taken along line I-I′ of FIG. 2, FIG. 4 is a cross-sectional view of the multilayer ceramic capacitor taken along line II-II′ of FIG. 2, and FIG. 5 is an exploded perspective view showing the stacked structure by disassembling the capacitor body of FIG. 2.

The L-axis, W-axis, and T-axis shown in FIGS. 2 to 5 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are, for example stacked. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are disposed. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 2 to 5, a multilayer ceramic capacitor 100 according to some embodiments includes the capacitor body 110 and external electrodes 131 and 132 disposed on an outer surface the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 may include a plurality of dielectric layers 111 and internal electrode layers 121 and 122. Specifically, the capacitor body 110 may include the plurality of dielectric layers 111 and a first internal electrode layer 121 and a second internal electrode layer 122 alternately disposed in the thickness direction (T-axis direction) interposing the dielectric layer 111.

Here, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately stacked, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be disposed on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include side margin regions.

The side margin regions are width-direction margin portions and may be disposed on opposite side ends of the active region in the width direction (W-axis direction), that is, on the fifth surface and the sixth surface, respectively. The side margin regions may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin regions may serve to prevent damage to the internal electrode layers 121 and 122 due to physical or chemical stress.

### Dielectric Layer

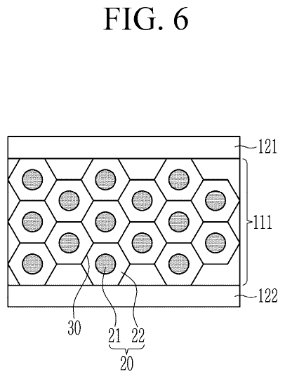

A dielectric layer according to an embodiment is described with reference to FIG. 6.

FIG. 6 is a schematic view showing a dielectric layer according to an embodiment.

Referring to FIG. 6, the dielectric layer 111 may include a plurality of dielectric grains 20 and a grain boundary 30 disposed between the plurality of dielectric grains 20.

At least one of the plurality of dielectric grains 20 may have a core-shell structure including a core portion 21 and a shell portion 22 disposed on at least a portion of the core portion 21. According to some embodiments, the shell portion 22 may be disposed on the entire surface of the core portion 21.

The dielectric layer 111 may be formed from a dielectric slurry including the aforementioned dielectric powder.

Specifically, the core portion 21 may include barium (Ba) and titanium (Ti), and the shell portion 22 and grain boundary 30 may include: at least one first element selected from the group consisting of silicon (Si) and aluminum (Al); and at least one second element selected from the group consisting of tin (Sn), copper (Cu), iron (Fe), zinc (Zn), and manganese (Mn). When both the shell portion 22 and the grain boundary 30 include the first element and the second element, damage to the core portion may be minimized by doping of the additive into the dielectric base material, and thus a multilayer ceramic capacitor with improved temperature characteristics and reliability may be secured. That is, the dielectric layer 111 according to some embodiments of the present disclosure may have a structure and components through controlling the diffusion of the additive component by the first barrier layer formed by coating the metal alkoxide-based compound and the second barrier layer formed by coating the metal oxide by using the aforementioned dielectric powder, thereby improving the temperature characteristics and reliability of the multilayer ceramic capacitor.

The component of the core portion 21 may be derived from a barium titanate-based compound used as a dielectric base material in the manufacture of the aforementioned dielectric powder. The barium titanate-based compound has high dielectric constant and contributes to forming the dielectric constant of a multilayer ceramic capacitor 100.

For example, the barium titanate-based compound may include at least one selected from the group consisting of BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃, and (Ba, Sr)(Ti, Sn)O₃.

The first element may be derived from the metal alkoxide-based compound that is primarily coated on the surface of the barium titanate-based compound during the preparation of the aforementioned dielectric powder, and the second element may be derived from the metal oxide that is secondarily coated on the surface of the metal alkoxide-based compound that is primarily coated during the preparation of the dielectric powder.

For example, the shell portion 22 and the grain boundary 30 may include silicon (Si) and tin (Sn).

The structure and components of the dielectric layer 111 may be confirmed through TEM-EDS (transmission electron microscope-energy dispersive spectroscopy). TEM-EDS may be measured by the following methods.

After placing a multilayer ceramic capacitor 100 in an epoxy mixing solution and curing it, the W-axis and T-axis direction surfaces (WT surfaces) of the capacitor body 110 are polished to ½ of a depth in the L-axis direction to obtain a cross-sectional sample so that the active region where the dielectric layer 111 and the internal electrode layers 121 and 122 intersect can be observed. Subsequently, when the active region of the cross-sectional sample is divided into three parts, an upper region, a central region, and a lower region, each region is measured using a transmission electron microscope (TEM) so that at least one dielectric layer and one internal electrode layer are visible. TEM may be measured under the conditions of 200 kV acceleration voltage and 450 k magnification using Xe-FIB (focused ion beam). Subsequently, EDS (energy dispersive spectroscopy) analysis is performed on the dielectric layer in the TEM image of the measured cross-sectional sample to confirm the structure and components of dielectric grains 20 having a core-shell structure and grain boundary 30.

At this time, the Dy element, which is a subcomponent, may be utilized as a method to more clearly identify the core portion 21, shell portion 22, and grain boundary 30. For example, when analyzing a TEM-EDS line along the major axis passing through a center of a dielectric grain having the core-shell structure, a region where Dy is greater than about 0.3 part by mole relative to 100 parts by mole of Ti may be defined as the grain boundary, a region where Dy is between about 0.15 part by mole and about 0.3 part by mole relative to 100 parts by mole of Ti may be defined as the shell portion, and a region where Dy is less than about 0.15 part by mole relative to 100 parts by mole of Ti may be defined as the core portion.

According to some embodiments, the molar ratio of the second element to the first element in the shell portion 22 may be greater than about 0.15 and less than about 1.0, for example, about 0.2 to about 0.9, about 0.3 to about 0.8, or about 0.4 to about 0.6. When the molar ratio of the second element to the first element in the shell portion 22 is within the above range, the temperature characteristics and reliability of the multilayer ceramic capacitor may be improved by minimizing damage to the core portion due to doping of the additive into the dielectric base material.

In addition, a molar ratio of the second element included in the shell portion 22 to the second element included in the grain boundary 30 may be greater than or equal to about 2.0 and less than about 6.0, for example, greater than or equal to about 3.0 and less than about 6.0, or greater than or equal to about 4.0 and less than about 6.0. When the molar ratio of the second element in the shell portion 22 to the second element in the grain boundary 30 is within the above range, the temperature characteristics and reliability of the multilayer ceramic capacitor may be improved by minimizing damage to the core portion due to doping of the additive into the dielectric base material.

That is, the dielectric layer 111 according to an embodiment uses the dielectric powder described above, so that the additive components exist in a predetermined ratio range in the shell portion and the grain boundary due to the diffusion control effect of the additive components through the first layer as the barrier layer formed by coating a metal alkoxide compound and the second layer as the barrier layer formed by coating a metal oxide. Accordingly, a multilayer ceramic capacitor with excellent temperature characteristics and reliability may be obtained.

The molar ratio of the second element to the first element in the shell portion 22 and the molar ratio of the second element in the shell portion 22 to the second element in the grain boundary 30 may be measured as follows.

After placing a multilayer ceramic capacitor 100 in an epoxy mixing solution and curing it, the W-axis and T-axis direction surfaces (WT surfaces) of the capacitor body 110 are polished to ½ of a depth in the L-axis direction to obtain a cross-sectional sample so that the active region where the dielectric layer 111 and the internal electrode layers 121 and 122 intersect may be observed. Subsequently, when the active region of the cross-sectional sample is divided into three parts, an upper region, a central region, and a lower region, each region is measured using a transmission electron microscope (TEM) so that at least one dielectric layer and one internal electrode layer are visible. TEM may be measured under the conditions of 200 kV acceleration voltage and 450 k magnification using Xe-FIB (focused ion beam).

Next, in each TEM image of the upper region, the central region, and the lower region, at least one dielectric grain having a core-shell structure is selected for each region, and then EDS line analysis can be performed on a straight-line section from the center of the dielectric grain to one grain boundary. For example, by selecting three dielectric grains from the upper region, four from the central region, and three from the lower region, EDS line analysis can be performed for each of a total of ten grains.

Subsequently, the molar ratio of the second element (E2) to the first element (E1) in the shell portion 22 may be obtained by measuring the E2/E1 molar ratio within the shell portion for each dielectric grain and taking the average value for a total of 10. At this time, the E2/E1 molar ratio within the shell portion for each dielectric grain may be obtained by measuring the E2/E1 molar ratios at three equally spaced points within the shell of one dielectric grain and then taking the average of these values, and the E2/E1 molar ratio at each point may be the molar ratio of the contents of E1 and E2 measured based on 100 parts by mole of Ti at that point.

In addition, the molar ratio of the second element in the shell portion 22 to the second element in the grain boundary 30 may be obtained by measuring the molar ratio of the second element in the shell portion to the second element in the grain boundary for each dielectric grain and taking the average value for a total of 10. At this time, the molar ratio of the second element in the shell portion to the second element in the grain boundary for each dielectric grain may be obtained by measuring the contents of the second element at three equally spaced points in the shell portion and three equally spaced points in the grain boundary of one dielectric grain, and then taking an average value of the molar ratio of the second element in the shell portion to the second element in the grain boundary for three arbitrary cases. Additionally, the content of the second element at each point may be measured on the basis of 100 parts by mole of Ti at that point.

In addition to the aforementioned components, the dielectric layer 111 may further include one or more subcomponents selected from manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V), and may further include, for example, dysprosium (Dy).

An average thickness (an average length in a T-axis direction) of the dielectric layer 111 may be about 0.1 μm to about 8.0 μm, for example, about 0.1 μm to about 6.0 μm. If the dielectric layer 111 has an average thickness within the ranges, the multilayer ceramic capacitor may exhibit excellent reliability.

The average thickness of the dielectric layer 111 may be measured by placing the multilayer ceramic capacitor 100 in an epoxy mixing solution, curing it, polishing it, and then ion milling it, and then analyzing it using a scanning electron microscope (SEM). SEM may be measured under conditions of, for example, 10 kV and a magnification of 100 times, and may be measured so that at least 1 layer, 3 layers, 5 layers, or 10 layers of dielectric layers 111 are visible in the active region where the dielectric layer 111 and the internal electrode layers 121 and 122 intersect. In a SEM image, the central point in the length direction (L-axis direction) or the width direction (W-axis direction) of the dielectric layer 111 is used as a reference point, and the mean value of the thickness of the dielectric layer 111 at 10 points spaced apart from the reference point by a predetermined interval can be obtained. The intervals of the 10 points may be adjusted depending on the scale of the SEM image, and may be, for example, about 1 μm to about 100 μm, about 1 μm to about 50 μm, or about 1 μm to about 10 μm. Here, all 10 points should be disposed within the dielectric layer 111, and if all 10 points are not disposed within the dielectric layer 111, the position of the reference point may be changed, or the interval between the 10 points may be adjusted. Additionally, by extending this average measurement to 10 dielectric layers and measuring the average value, the average thickness of the dielectric layers can be more generalized.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 includes a conductive metal, and may include at least one selected from among metals such as Ni, Cu, Ag, Pd, Au, and an alloy thereof.

Additionally, the internal electrode layers 121 and 122 may include dielectric particles having the same composition as the ceramic material included in the dielectric layer 111.

The internal electrode layers 121 and 122 may be formed using a conductive paste including a conductive metal. The printing method for the conductive paste may be either screen printing or gravure printing.

An average thickness of the internal electrode layers 121 and 122 may be about 0.1 μm to about 2 μm.

The average thickness of the internal electrode layers 121 and 122 may be measured by scanning electron microscope (SEM) analysis. Specifically, in the SEM image of the cross-sectional sample obtained by the same method as the method for measuring the average thickness of the dielectric layer 111, the central point in the length direction (L-axis direction) or the width direction (W-axis direction) of the internal electrode layers 121 and 122 is used as a reference point, and the mean value of the thickness of the internal electrode layers 121 and 122 at 10 points spaced apart from the reference point by a predetermined interval can be obtained. The intervals of the 10 points may be adjusted depending on the scale of the scanning electron microscope (SEM) image, and may be, for example, about 1 μm to about 100 μm, about 1 μm to about 50 μm, or about 1 μm to about 10 μm. At this time, all 10 points should be disposed within the internal electrode layers 121 and 122, and if all 10 points are not disposed within the internal electrode layers 121 and 122, the location of the reference point can be changed or the interval between the 10 points can be adjusted. In addition, by extending this average value measurement to 10 internal electrode layers and measuring the average value, the average thickness of the internal electrode layers may be more generalized.

The capacitor body 110 may be formed by firing a stacked structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from silicon oxide, boron oxide, aluminum oxide, transition metal oxide, alkali metal oxide, and alkaline earth metal oxide. The transition metal may be selected from zinc (Zn), titanium (Ti), copper (Cu), vanadium (V), manganese (Mn), iron (Fe) and nickel (Ni), the alkali metal may be selected from lithium (Li), sodium (Na) and potassium (K), and the alkaline-earth metal may be at least one selected from magnesium (Mg), calcium (Ca), strontium (Sr), and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outer surface the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outer surface, heat resistance, and equivalent series resistance (ESR) of the multilayer capacitor 100.

Hereinafter, a method of manufacturing the multilayer ceramic capacitor 100 according to an embodiment will be described.

A multilayer ceramic capacitor 100 according to an embodiment may be manufactured by preparing a dielectric slurry including the aforementioned dielectric powder; manufacturing a dielectric green sheet using the dielectric slurry and forming a conductive paste layer on the surface of the dielectric green sheet; manufacturing a dielectric green sheet stack by stacking the dielectric green sheet on which the conductive paste layer is formed; firing the dielectric green sheet stack to manufacture a capacitor body including a dielectric layer and an internal electrode layer; and forming an external electrode on one surface of the capacitor body.

As described above, the dielectric powder may be prepared by primarily coating the metal alkoxide-based compound on the surface of the barium titanate-based compound, and then secondarily coating a metal oxide on the surface of the first-coated metal alkoxide-based compound.

The dielectric slurry may further include a subcomponent powder, i.e., a subcomponent-containing compound.

The subcomponent-containing compound may include a compound containing one or more subcomponents selected from the group consisting of manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V), and may include, for example, a dysprosium (Dy)-containing compound.

The subcomponent-containing compound may be at least one of an oxide, nitride or salt compound of the subcomponent, and may also be a compound in the form of a sol dispersed in an organic solvent.

The subcomponent-containing compound may be included in an amount of about 0.9 part by mole to about 1.5 parts by mole of the subcomponent based on 100 parts by mole of the barium titanate-based compound.

The dielectric slurry may be prepared by additionally mixing additives such as a dispersant, a binder, a plasticizer, a lubricant, an antistatic agent, and a solvent.

The dispersant may include for example a phosphoric acid ester-based dispersant, a polycarboxylic acid-based dispersant, or a combination thereof. The dispersant may be mixed in an amount of about 0.1 part by weight to about 5 parts by weight, for example, about 0.3 part by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduced.

The binder may include, for example, an acrylic resin, a polyvinyl butyl resin, a polyvinyl acetal resin, an ethyl cellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry may exhibit excellent dispersibility, and the amount of impurities included in the manufactured dielectric layer may be reduced.

The plasticizer may include, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry may exhibit excellent dispersibility, and the amount of impurities included in the manufactured dielectric layer may be reduced.

The solvent may include an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may include, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

In order to form a conductive paste layer that becomes an internal electrode layer after firing, a conductive paste may be prepared by mixing a conductive powder made of a conductive metal or an alloy thereof, a binder, and a solvent. Additionally, barium titanate powder may be mixed in as a co-material if necessary. The co-material can act to inhibit the sintering of the conductive powder during the sintering process. In the manufacturing of the dielectric green sheet, a dielectric slurry may be prepared by mixing a barium titanate-based compound as a main component powder and optionally a subcomponent powder.

The conductive powder may include nickel (Ni) or a nickel (Ni) alloy.

Next, a dielectric green sheet stack is manufactured by stacking a plurality of layers of dielectric green sheets on which internal electrode layer patterns are formed, and then pressing the plurality of layers of dielectric green sheets in the stacking direction. At this time, the dielectric green sheet and the internal electrode layer pattern may be stacked so that the dielectric green sheet is disposed on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 hour to about 8 hours, for example, about 1 hour to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. The annealing atmosphere can be a humidified nitrogen gas (N₂) atmosphere, and the oxygen partial pressure can be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethyl cellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and fired at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethyl cellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outer surface of the conductive resin layer.

For example, the plating layer may be formed by a plating method, sputtering, or electrolytic plating (electric deposition).

Hereinafter, the embodiments of the present disclosure are illustrated in more detail with reference to examples. However, these examples are exemplary, and the scope of claims is not limited thereto.

### PREPARATION OF DIELECTRIC POWDER

### Preparation Example 1

Tetraethyl orthosilicate (TEOS) was added to a slurry containing BaTiO₃ powder dispersed in an aqueous solution, and then hydrothermal treatment was performed at 200° C. to perform a primary coating of TEOS on the surface of BaTiO₃. At this time, TEOS was added in an amount such that Si was 0.24 part by mole based on 100 parts by mole of BaTiO₃. Subsequently, SnO₂ was added to the slurry including the primarily-coated intermediate, and then hydrothermal treatment was performed at 250° C. to perform a second coating of SnO₂ on the surface of the primarily-coated TEOS, thereby preparing a dielectric powder. At this time, SnO₂ was introduced in the form of a sol dispersed in ammonia water, and SnO₂ was introduced in an amount such that Sn was 1 part by mole based on 100 parts by mole of BaTiO₃.

### Preparation Example 2

A dielectric powder was prepared using the same method as Preparation Example 1, except that TEOS was added in an amount such that Si was 0.41 part by mole based on 100 parts by mole of BaTiO₃.

### Preparation Example 3

A dielectric powder was prepared using the same method as Preparation Example 1, except that SnO₂ was added in an amount of 1.5 parts by mole of Sn based on 100 parts by mole of BaTiO₃.

### Preparation Example 4

A dielectric powder was prepared using the same method as Preparation Example 1, except that SnO₂ was added in an amount of 2 parts by mole of Sn based on 100 parts by mole of BaTiO₃.

### Comparative Preparation Example 1

A dielectric powder was prepared by adding SnO₂ to a slurry including BaTiO₃ powder dispersed in an aqueous solution and then thermally treating the slurry at 250° C. to coat the surface of BaTiO₃ with SnO₂. At this time, SnO₂ was introduced in the form of a sol dispersed in ammonia water, and SnO₂ was introduced in an amount such that Sn was 1 part by mole based on 100 parts by mole of BaTiO₃.

### (Manufacturing of Multilayer Ceramic Capacitor)

### Example 1

A dielectric slurry was prepared by mixing the dielectric powder prepared in Preparation Example 1 and the subcomponent powder including Dy₂O₃. Dy₂O₃ was mixed in an amount of 1.3 parts by mole of Dy based on 100 parts by mole of BaTiO₃ used in the preparation of the dielectric powder. In preparing the dielectric slurry, the mixing was performed through mechanical milling by using zirconia (ZrO₂) balls as a dispersive medium after adding ethanol/toluene, a wetting dispersant, and a polyvinyl butyral (PVB) resin as a binder together.

The prepared dielectric slurry was used to manufacture a dielectric green sheet by using a head discharge type on-roll forming coater.

On the surface of the dielectric green sheet, a conductive paste layer including nickel (Ni) was printed and then, another dielectric green sheet having another conductive paste layer was stacked thereon and then, compressed to manufacture a dielectric green sheet stack.

The dielectric green sheet stack was calcinated at 400° C. or less under a nitrogen atmosphere and fired at 1300° C. or less at a hydrogen (H₂) concentration of 1.0% or less.

Subsequently, a multilayer ceramic capacitor was manufactured through processes of an external electrode, plating, or the like.

### Example 2

A multilayer ceramic capacitor was manufactured in the same manner as in Example 1, except that the dielectric powder prepared in Preparation Example 2 was used instead of the dielectric powder prepared in Preparation Example 1.

### Example 3

A multilayer ceramic capacitor was manufactured in the same manner as in Example 1, except that the dielectric powder prepared in Preparation Example 3 was used instead of the dielectric powder prepared in Preparation Example 1.

### Example 4

A multilayer ceramic capacitor was manufactured in the same manner as in Example 1, except that the dielectric powder prepared in Preparation Example 4 was used instead of the dielectric powder prepared in Preparation Example 1.

### Comparative Example 1

A multilayer ceramic capacitor was manufactured in the same manner as in Example 1, except that a dielectric slurry was prepared by mixing BaTiO₃ and subcomponent powders including SiO₂ and Dy₂O₃.

### Evaluation 1: Confirmation of Structure and Composition of Dielectric Powder

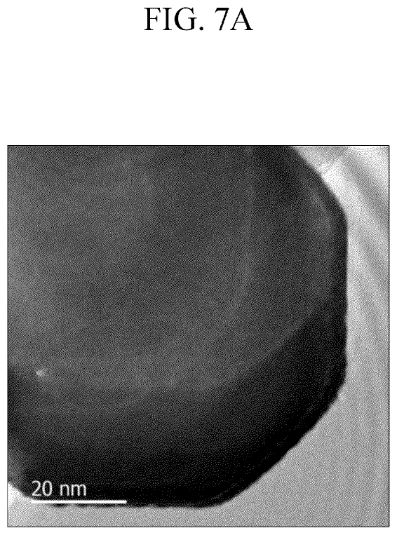

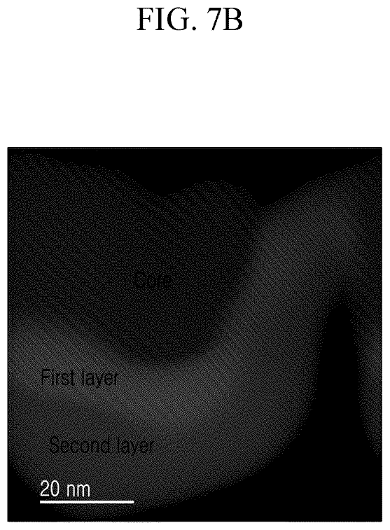

In order to confirm the structure of the dielectric powder prepared in Preparation Example 1, HR-TEM (high-resolution transmission electron microscopy) analysis and IFFT HR-TEM (inverse Fourier transform high-resolution transmission electron microscopy) analysis were performed, and the results are shown in FIGS. 7A and 7B.

HR-TEM analysis and IFFT HR-TEM analysis were performed under the conditions of an acceleration voltage of 200 kV and a magnification of 630 k for the dielectric powder.

FIG. 7A is an HR-TEM (high-resolution transmission electron microscope) analysis image of the dielectric powder according to Preparation Example 1 and FIG. 7B is an IFFT HR-TEM (inverse Fourier transform high-resolution transmission electron microscope) analysis image of the dielectric powder according to Preparation Example 1.

Referring to FIGS. 7A and 7B, the dielectric powder of Preparation Example 1 was confirmed to have a structure including a core, a first layer disposed on at least a portion of the core, and a second layer disposed on at least a portion of the first layer. In addition, thereinside, the core of BaTiO₃ existed without damage, but on the outside, the layer with a changed crystal structure was distributed due to the metal oxide coating.

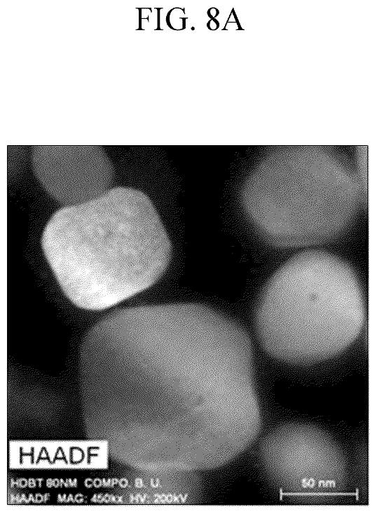

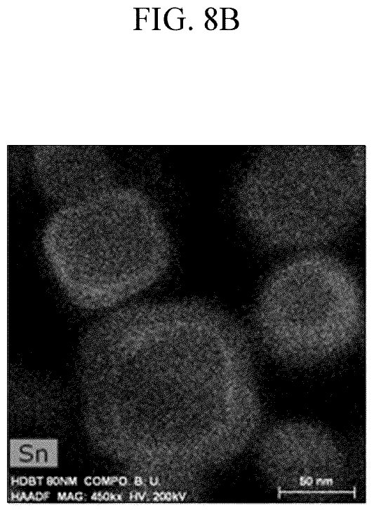

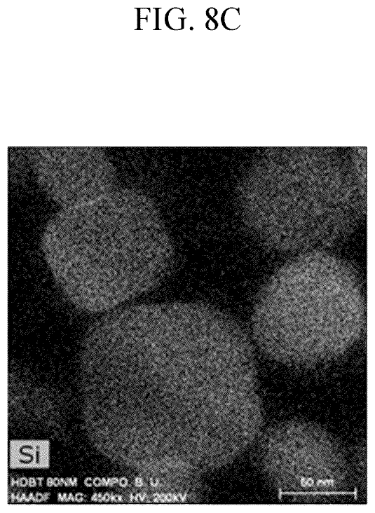

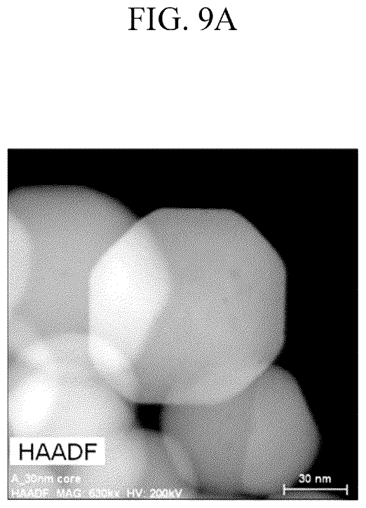

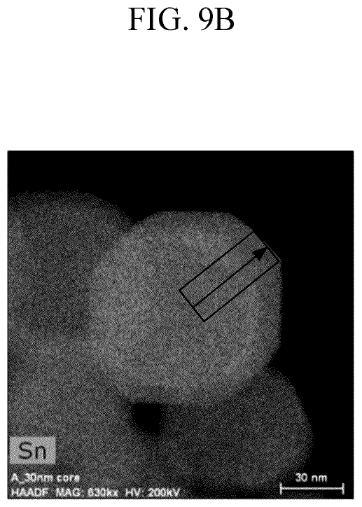

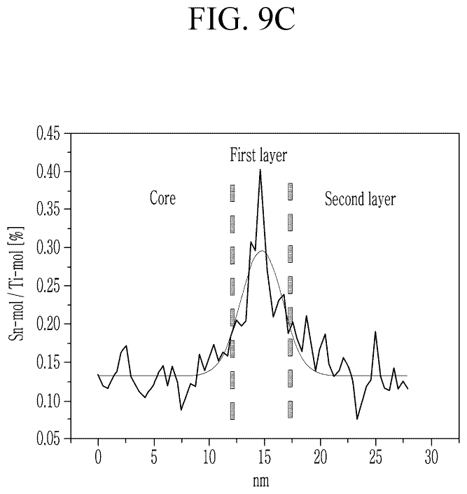

In addition, the dielectric powder of Preparation Example 1 was subjected to a TEM-EDS (transmission electron microscope-energy dispersive spectroscopy) analysis to check a structure and a component, and the results are shown in FIGS. 8A to 8C and FIGS. 9A to 9C.

The TEM-EDS analysis was performed as follows. The dielectric powder was taken an image of with TEM (transmission electron microscope) under conditions of an acceleration voltage of 200 kV and a magnification of 630 k, and the TEM image was subjected to an EDS (energy dispersive spectroscopy) analysis to check the structure and component of the dielectric powder. In addition, in the obtained TEM image, the EDS line analysis was performed on a straight-line section from a center of the dielectric powder to either side boundary thereof to check a composition of the dielectric powder.

FIGS. 8A to 8C are the TEM-EDS (transmission electron microscope-energy dispersive spectroscopy) analysis images of the dielectric powder according to Preparation Example 1. FIGS. 9A and 9B are the TEM-EDS (transmission electron microscope-energy dispersive spectroscopy) line analysis images for the dielectric powder according to Preparation Example 1, and FIG. 9C is the TEM-EDS (transmission electron microscope-energy dispersive spectroscopy) line analysis graph for the dielectric powder according to Preparation Example 1.

Referring to FIGS. 8A to 8C, the dielectric powder of Preparation Example 1 was confirmed to have a structure including a core, a first layer disposed on at least a portion of the core, and a second layer disposed on at least a portion of the first layer, wherein both Si and Sn existed in the first and second layers. In addition, in the dielectric powder, the metal oxide was not further diffused into the inside due to the barrier layer of the first layer but formed the barrier layer of the second layer.

In addition, referring to the TEM-EDS line analysis result of FIGS. 9A to 9C, the core, the first layer, and the second layer were distinguished based on a point where Sn was 0.2 part by mole based on 100 parts by mole of Ti. In other words, the first layer was a region where Sn was greater than or equal to about 0.2 part by mole based on 100 parts by mole of Ti, but the core and the second layer were less than 0.2 part by mole based on 100 parts by mole of Ti, wherein the core was defined as an internal region toward the center of the dielectric powder with reference to the first layer, while the second layer was an external region toward the outside of the dielectric powder with reference to the first layer.

### Evaluation 2: TEM-EDS Analysis of Dielectric Layer

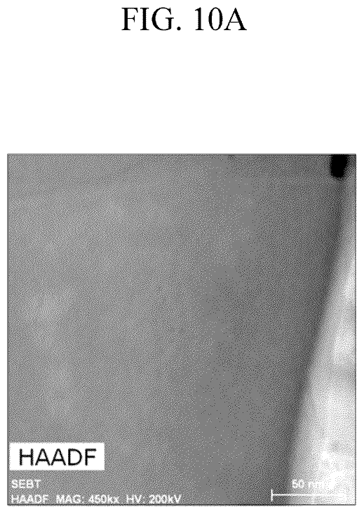

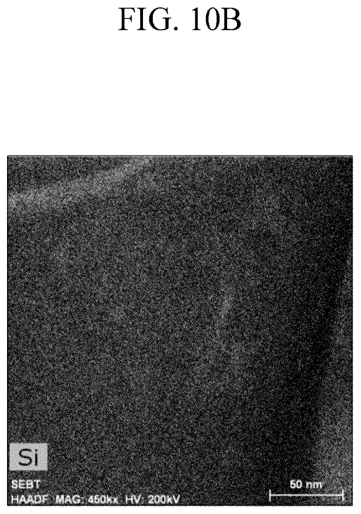

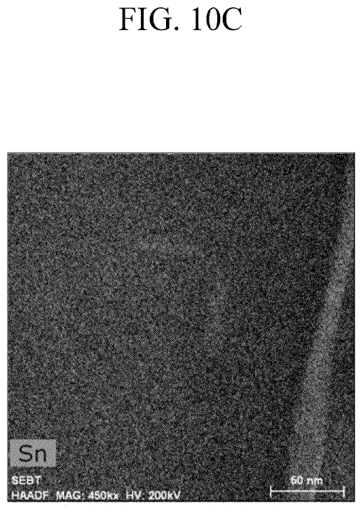

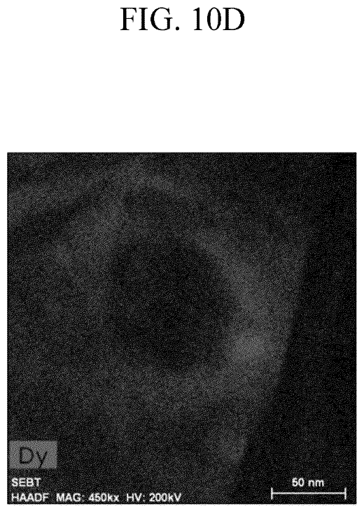

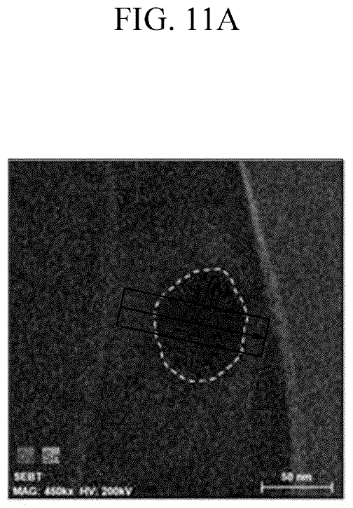

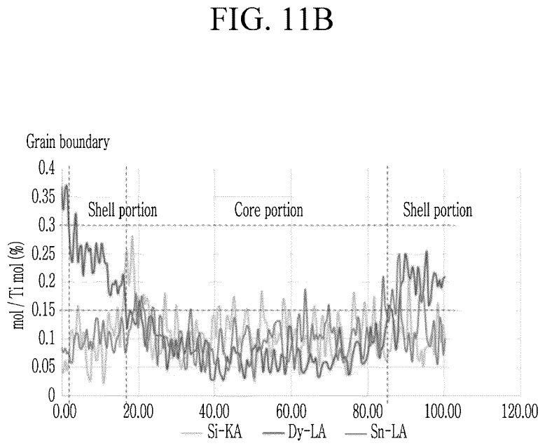

The dielectric layers of the multilayer ceramic capacitors according to Examples 1 to 4 and Comparative Example 1 were subjected to TEM-EDS (transmission electron microscope-energy dispersive spectroscopy) analysis in the following method, and the results are shown in FIGS. 10A to 10D and FIGS. 11A and 11B.

Each of the multilayer ceramic capacitors was placed in an epoxy mixing solution and cured and then, polished on the W-axis and T-axis direction surface (WT plane) to a depth of ½ in a L-axis direction to obtain a cross-sectional sample for examining an active region where a dielectric layer intersected an internal electrode layer. Subsequently, when the active region of the cross-sectional sample was divided into three regions such as upper region, center region, and lower region, each region was taken an image of with TEM (transmissionelectron microscope), so that at least one dielectric layer and internal electrode layer could be observed. The TEM image was obtained by using an Xe-FIB (focused ion beam) under conditions of an acceleration voltage of 200 kV and a magnification of 450k. Subsequently, the TEM image of the cross-sectional sample was subjected to EDS (energy dispersive spectroscopy) analysis with respect to a dielectric layer.

In addition, in the TEM image of the cross-sectional sample, a TEM-EDS line analysis was performed along a major axis passing through a center of dielectric grains with a core-shell structure.

FIGS. 10A to 10D are TEM-EDS (transmission electron microscopy-energy dispersive spectroscopy) mapping analysis images for a dielectric layer according to Example 1. FIG. 11A is a TEM-EDS (transmission electron microscope-energy dispersive spectroscopy) line analysis image for a dielectric layer according to Example 1, and FIG. 11B is a TEM-EDS (transmission electron microscope-energy dispersive spectroscopy) line analysis graph for a dielectric layer according to Example 1.

Referring to FIGS. 10A to 10D, the dielectric layer of Example 1 was confirmed to include a dielectric grain with the core-shell structure and a grain boundary, wherein Si and Sn existed in both shell portion and grain boundary.

Also, referring to the TEM-EDS line analysis results of FIGS. 11A and 11B, in the TEM-EDS line analysis along the major axis passing through the center of the dielectric grain having the core-shell structure, a region where Dy is greater than about 0.3 part by mole relative to 100 parts by mole of Ti may be defined as a grain boundary, a region where Dy is between about 0.15 part by mole and about 0.3 part by mole relative to 100 parts by mole of Ti may be defined as a shell portion, and a region where Dy is less than about 0.15 part by mole relative to 100 parts by mole of Ti may be defined as a core portion.

In addition, an Sn/Si molar ratio (X) in the shell portion and a molar ratio (Y) of Sn in the shell portion to Sn in the grain boundary were measured in the following method, and the results are shown in Table 1.

In each TEM image of the upper region, center region, and lower region in the active region, three, four, and three dielectric grains from each region and thus ten dielectric grains with a core-shell structure in total were selected. A straight-line section from a center of each of the selected dielectric grains to either side grain boundary thereof was subjected to EDS line analysis.

Subsequently, in Table 1, X was obtained by measuring an Sn/Si molar ratio within a shell portion for each dielectric grain and calculating an average value of ten measurements in total. Herein, the Sn/Si molar ratio of the shell portion for each dielectric grain was obtained by measuring an Sn/Si molar ratio at three equally-spaced points in one dielectric grain and calculating an average value of the measurements. In addition, the Sn/Si molar ratio at each point was a molar ratio of Sn and Si contents based on 100 parts by mole of Ti.

Furthermore, in Table 1, Y was obtained by measuring a molar ratio of Sn in a shell portion to Sn at a grain boundary for each dielectric grain and calculating an average value of the ten measurements in total. Herein, the molar ratio of Sn in a shell portion to Sn in a grain boundary for each dielectric grain was obtained by measuring each Sn content at three equally-spaced point in the shell portion and each Sn content at three equally-spaced point in the grain boundary for one dielectric grain and calculating an average value thereof

In addition, the Sn content at each point was measured based on 100 parts by mole of Ti at each point.

TABLE 1

| | X | Y |
|---|---|---|
| | (Sn/Si molar ratio | (Molar ratio of Sn in shell |
| | in shell portion) | portion/Sn in grain boundary) |
| Example 1 | 0.57 | 5.75 |
| Example 2 | 0.48 | 4.78 |
| Example 3 | 5.33 | 3.61 |
| Example 4 | 1.02 | 8.68 |
| Comparative | 0 | 0 |
| Example 1 | | |

### Evaluation 3: Dielectric Constant

The dielectric constants of the multilayer ceramic capacitors according to Examples 1 to 4 and Comparative Example 1 were measured under the conditions of 1 KHz and 0.5 V, and the results are shown in Table 2.

### Evaluation 4: Temperature Characteristics

The multilayer ceramic capacitors of Examples 1 to 4 and Comparative Example 1 were measured with respect to temperature coefficient of capacitance (TCC), and the results are shown in Table 2.

TCC was measured under conditions of 1 kHz, 0.01 V, and holding time of 5 minutes.

### Evaluation 5: Reliability

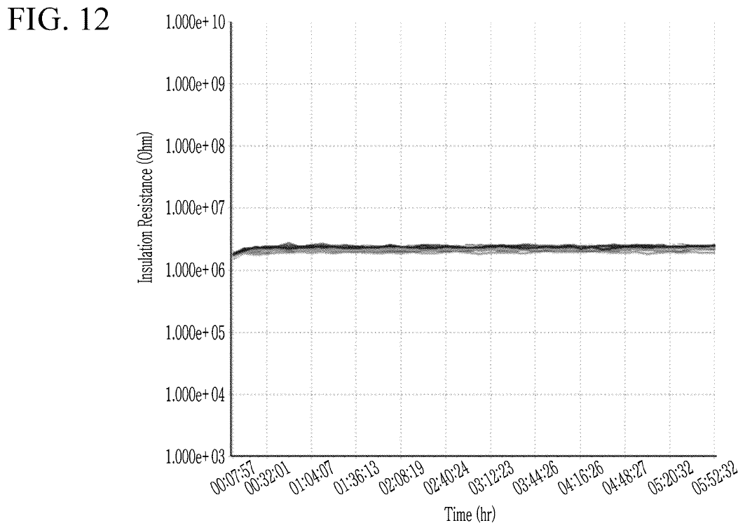

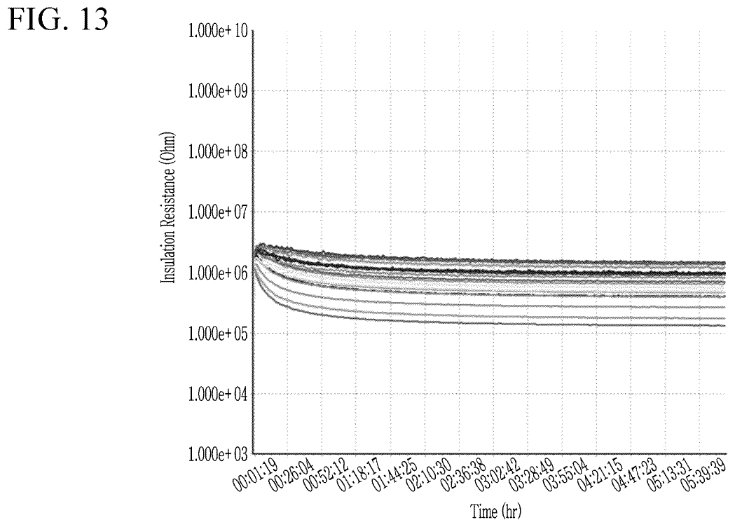

The multilayer ceramic capacitors of Examples 1 to 4 and Comparative Example 1 were measured with respect to mean time to failure (MTTF) in the following method, and the results are shown in Table 2 and FIGS. 12 and 13.

MTTF (mean time to failure) (hr) was obtained by calculating an average value for 20 samples of each multilayer ceramic capacitor under conditions of a temperature of 125° C., a voltage of 9.45 V, and 48 hours.

FIG. 12 is a graph showing the reliability of the multilayer ceramic capacitor according to Example 1, and FIG. 13 is a graph showing the reliability of the multilayer ceramic capacitor according to Comparative Example 1.

Referring to FIGS. 12 and 13, Example 1 exhibited excellent reliability, compared with Comparative Example 1.

TABLE 2

| | Dielectric constant | TCC (%) (@105° C.) | MTTF (hr) |
|---|---|---|---|
| Example 1 | 3910 | −20 | 66 |
| Example 2 | 3750 | −21 | 61 |
| Example 3 | 3620 | −26 | 55 |
| Example 4 | 3630 | −25 | 31 |
| Comparative | 3150 | −27 | 27 |
| Example 1 | | | |

Referring to Table 2, Examples 1 to 4, compared with Comparative Example 1, exhibited a high dielectric constant, excellent temperature characteristics due to small capacitance change at a high temperature, and excellent reliability. Accordingly, a multilayer ceramic capacitor using the dielectric powder according to the embodiment of the present disclosure, in which a dielectric layer included a dielectric grain with a core-shell structure and a grain boundary, and a shell portion and a grain boundary included Si and Sn, exhibited excellent temperature characteristics and reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: dielectric powder
11: core
12: first layer
13: second layer
20: dielectric grain
21: core portion
22: shell portion
30: grain boundary
100: multilayer ceramic capacitor
110: capacitor body
111: dielectric layer
121: first internal electrode layer
122: second internal electrode layer
131: first external electrode
132: second external electrode

What is claimed is:

1. A dielectric powder, comprising
a core comprising barium (Ba) and titanium (Ti);
a first layer disposed on at least a portion of the core; and
a second layer disposed on at least a portion of the first layer,
wherein at least one of the first layer or the second layer comprises a first element,
the first element is selected from the group consisting of silicon (Si) and aluminum (Al),
the first layer and the second layer comprise a second element, and
the second element is selected from the group consisting of tin (Sn), copper (Cu), iron (Fe), zinc (Zn), and manganese (Mn).

2. The dielectric powder of claim 1, wherein
the first layer and the second layer comprise tin (Sn), and
when analyzing a transmission electron microscope-energy dispersive spectroscopy (TEM-EDS) for a straight-line section from a center of the dielectric powder to one boundary,
the first layer is a region where tin (Sn) is greater than or equal to 0.2 part by mole based on 100 parts by mole of titanium (Ti), and
the core and the second layer are regions where tin (Sn) is less than 0.2 part by mole based on 100 parts by mole of titanium (Ti).

3. The dielectric powder of claim 1, wherein
a content of the second element is higher in the first layer than in the second layer.

4. The dielectric powder of claim 1, wherein
the first layer and the second layer comprise the first element.

5. The dielectric powder of claim 1, wherein
the first layer and the second layer comprise the second element in a form of an oxide.

6. The dielectric powder of claim 1, wherein
at least one of the first layer or the second layer comprises silicon (Si),
the first layer and the second layer comprise tin (Sn).

7. The dielectric powder of claim 1, wherein
the first layer and the second layer comprise silicon (Si) and tin (Sn).

8. A multilayer ceramic capacitor, comprising
a capacitor body comprising a dielectric layer and an internal electrode layer, and
an external electrode disposed on an outer surface of the capacitor body,
wherein the dielectric layer comprises a plurality of dielectric grains and a grain boundary disposed between the plurality of dielectric grains,
at least one of the plurality of dielectric grains has a core-shell structure comprising a core portion and a shell portion disposed on at least a portion of the core portion, and
the shell portion and the grain boundary comprise at least one first element selected from the group consisting of silicon (Si) and aluminum (Al), and at least one second element selected from the group consisting of tin (Sn), copper (Cu), iron (Fe), zinc (Zn), and manganese (Mn).

9. The multilayer ceramic capacitor of claim 8, wherein
a molar ratio of the second element to the first element in the shell portion is greater than 0.15 and less than 1.0.

10. The multilayer ceramic capacitor of claim 8, wherein
a molar ratio of the second element included in the shell portion to the second element included in the grain boundary is greater than or equal to 2.0 and less than 6.0.

11. The multilayer ceramic capacitor of claim 8, wherein
the core portion comprises barium (Ba) and titanium (Ti).

12. The multilayer ceramic capacitor of claim 8, wherein
the shell portion and the grain boundary comprise silicon (Si) and tin (Sn).

13. A multilayer ceramic capacitor, comprising
a capacitor body comprising a dielectric layer and an internal electrode layer, and
an external electrode disposed on an outer surface of the capacitor body,
wherein the dielectric layer is prepared from the dielectric powder of claim 1, and comprises a plurality of dielectric grains and a grain boundary disposed between the plurality of dielectric grains,
at least one of the plurality of dielectric grains has a core-shell structure comprising a core portion and a shell portion disposed on at least a portion of the core portion, and
the shell portion and the grain boundary comprise at least one first element selected from the group consisting of silicon (Si) and aluminum (Al), and at least one second element selected from tin (Sn), copper (Cu), iron (Fe), zinc (Zn), and manganese (Mn).

14. The multilayer ceramic capacitor of claim 13, wherein
a molar ratio of the second element to the first element in the shell portion is greater than 0.15 and less than 1.0.

15. The multilayer ceramic capacitor of claim 13, wherein
a molar ratio of the second element included in the shell portion to the second element included in the grain boundary is greater than or equal to 2.0 and less than 6.0.

16. The multilayer ceramic capacitor of claim 13, wherein
the core portion comprises barium (Ba) and titanium (Ti).

17. The multilayer ceramic capacitor of claim 13, wherein
the shell portion and the grain boundary comprise silicon (Si) and tin (Sn).

18. A method for preparing the dielectric powder of claim 1, comprising
adding a metal alkoxide-based compound to a solution comprising a barium titanate-based compound,
performing a hydrothermal treatment to primarily coat the metal alkoxide-based compound on a surface of the barium titanate-based compound; and
adding a metal oxide to secondarily coat the metal oxide on a surface of the metal alkoxide-based compound,
wherein the metal alkoxide-based compound comprises at least one metal selected from the group consisting of silicon (Si) and aluminum (Al), and
the metal oxide comprises at least one metal selected from the group consisting of tin (Sn), copper (Cu), iron (Fe), zinc (Zn), and manganese (Mn).

19. The method of claim 18, wherein
the metal alkoxide-based compound comprises at least one selected from the group consisting of tetraethyl orthosilicate (TEOS), aluminum isopropoxide, and aluminum ethoxide.

20. The method of claim 18, wherein
the metal alkoxide-based compound is added in an amount such that the at least one metal of the metal alkoxide-based compound is in an amount of 0.1 part by mole to 1 part by mole based on 100 parts by mole of the barium titanate-based compound.

21. The method of claim 18, wherein
the metal oxide comprises at least one selected from tin oxide (SnO₂), copper oxide (CuO), FeO, Fe₃O₄, Fe₂O₃, zinc oxide (ZnO), and manganese dioxide (MnO₂).

22. The method of claim 18, wherein
the metal oxide is added in an amount such that the metal of the metal oxide is in an amount of 0.1 part by mole to 3 parts by mole based on 100 parts by mole of the barium titanate-based compound.

23. The method of claim 18, wherein
in the primary coating, the hydrothermal treatment is performed at a temperature of 100° C. to 300° C.

24. The method of claim 18, wherein
in the secondary coating, the hydrothermal treatment is performed at a temperature of 150° C. to 350° C.
